(19) United States
(12) Patent Application Publication
(10) Pub. No.: US 2004/0170932 A1
(43) Pub. Date: Sep. 2, 2004

(54) Method of manufacturing a multilayer thermal imaging member

(76) Inventors: John M. Hardin, Hopkinton, MA (US); James J. Manning, Braintree, MA (US)

Correspondence Address: POLAROID CORPORATION, PATENT DEPARTMENT, 1265 MAIN STREET, WALTHAM, MA, 02451, US

(21) Appl. No.: 10/786,920

(22) Filed: Feb. 25, 2004

Related U.S. Application Data
(60) Provisional application No. 60/450,986, filed on Feb. 28, 2003.

(51) Int. Cl. G03C 1/76; G03C 7/02; G03C 7/46; G03C 11/22

(52) U.S. Cl. 430/335; 430/338; 430/394; 430/502; 430/536; 430/961; 430/964

(57) ABSTRACT

There is described a method for forming an overcoat layer on a multilayer thermal imaging member by subjecting a layer of an overcoat composition including an oligomer having an acrylate function and a photoinitiator to ultraviolet or electron beam radiation. Multilayer thermal imaging members having an overcoat layer formed according to the method of the invention are also described.

### REFERENCE TO RELATED APPLICATION

This application claims the benefit of U.S. provisional application serial No. 60/450,986, filed Feb. 28, 2003.

This application is related to commonly assigned patent application Ser. No. 10/151,432 filed May 20, 2002, which is hereby incorporated by reference herein in its entirety.

### FIELD OF THE INVENTION

The present invention relates generally to multilayer thermal imaging members and a method for their manufacture and, more particularly, to such thermal imaging members wherein an overcoat layer is formed by an ultraviolet or electron beam curing step.

As the state of the thermal imaging art advances and new thermal imaging members are disclosed, there is also a need for new overcoat layers for such imaging members and for techniques for forming the overcoat layers.

### SUMMARY OF THE INVENTION

It is an object of the invention to provide multilayer thermal imaging members.

It is another object of this invention to provide multilayer thermal imaging members having an overcoat layer formed by an ultraviolet or electron beam curing step.

Another object is to provide multilayer thermal imaging members having an overcoat layer formed by ultraviolet or electron beam curing of a composition including an oligomer having an acrylate function and a photoinitiator.

It is yet another object of the invention to provide a method for manufacturing multilayer thermal imaging members.

Still another object of the invention is to provide a method for making a multilayer thermal imaging member which includes forming an overcoat layer by an ultraviolet or electron beam curing step.

In one aspect of the invention there are provided multilayer thermal imaging members having an overcoat layer which is formed by an ultraviolet or electron beam curing step which initiates a polymerization reaction of an oligomer having an acrylate function. Generally, a formulation is prepared which includes an oligomer having an acrylate function, a photoinitiator, an optional monomer having an acrylate function, and an optional photosensitizer. The formulation may also include other components such as slip agents as will be described in detail below.

The formulation, preferably dissolved or dispersed in an organic solvent, is coated onto the preceding layer of the multilayer imaging member and subjected to ultraviolet or electron beam radiation to form the overcoat layer.

### BRIEF DESCRIPTION OF THE DRAWINGS

For a better understanding of the invention as well as other objects and advantages and further features thereof, reference is made to the following detailed description of various preferred embodiments thereof taken in conjunction with the accompanying drawings wherein:

FIG. 1 is a partially schematic, side sectional view of a two color imaging member upon which an overcoat layer can be formed according to the invention;

FIG. 2 is a partially schematic, side sectional view of a three color imaging member upon which an overcoat layer can be formed according to the invention;

FIG. 3 is a partially schematic, side sectional view of a three color imaging member including an overcoat layer formed according to the invention;

FIG. 4 is a partially schematic, side sectional view of a multicolor imaging member upon which an overcoat layer can be formed according to the invention;

FIG. 5 is a partially schematic, side sectional view of a negative-working multicolor imaging member upon which an overcoat layer can be formed according to the invention; and

FIG. 6 is a partially schematic, side sectional view of a three color imaging member upon which an overcoat layer can be formed according to the invention.

### DESCRIPTION OF THE PREFERRED EMBODIMENTS

The method of the invention can be used to form an overcoat layer on any thermal imaging member. In a preferred embodiment, the method of the invention is used to form an overcoat layer on the thermal imaging members disclosed and claimed in prior, copending commonly assigned patent application Ser. No. 10/151,432 filed May 20, 2002, which is hereby incorporated herein in its entirety and made a part of this application.

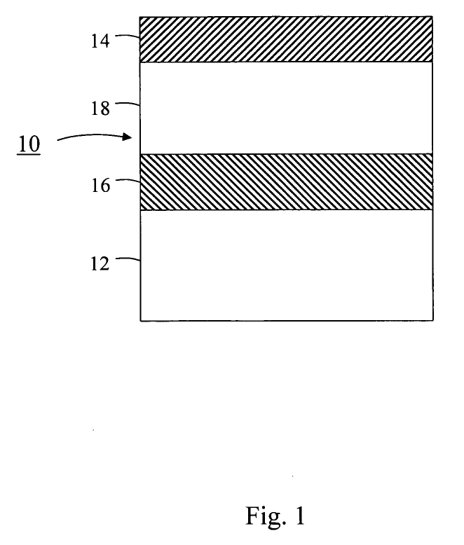

Referring now to FIG. 1 there is seen a multicolor thermal imaging member that can be manufactured according to the invention. Imaging member 10 includes a substrate 12 carrying cyan and magenta image-forming layers, 14 and 16, respectively, and spacer interlayer 18. It should be noted here that in various embodiments of the invention the image-forming layers may themselves comprise two or more separate layers. For example, where the image-forming material is a leuco dye which is used in conjunction with a developer material, the leuco dye and developer material may be disposed in separate layers.

Substrate 12 may be of any suitable material for use in thermal imaging members, such as polymeric materials, and may be transparent or reflective. Any combination of materials that may be thermally induced to change color may be used in the image-forming layers 14 and 16. The materials may react chemically under the influence of heat, either as a result of being brought together by a physical mechanism, such as melting or diffusion, or through thermal acceleration of a reaction rate. The reaction may be chemically reversible or irreversible.

For example, a colorless dye precursor may form color upon heat-induced contact with a reagent. This reagent may be a Bronsted acid, as described in “Imaging Processes and Materials”, Neblette's Eighth Edition, J. Sturge, V. Walworth, A. Shepp, Eds., Van Nostrand Reinhold, 1989, pp. 274-275, or a Lewis acid, as described for example in U.S. Pat. No. 4,636,819. Suitable dye precursors for use with acidic reagents are described, for example, in U.S. Pat. No. 2,417,897, South African Patent 68-00170, South African Patent 68-00323 and Ger. Offen. 2,259,409. Further examples of such dyes may be found in “Synthesis and Properties of Phthalide-type Color Formers”, by Ina Fletcher and Rudolf Zink, in “Chemistry and Applications of Leuco Dyes”, Muthyala Ed., Plenum Press, New York, 1997. Such dyes may comprise a triarylmethane, diphenylmethane, xanthene, thiazine or spiro compound, for example, Crystal Violet Lactone, N-halophenyl leuco Auramine, rhodamine B anilinolactam, 3-piperidino-6-methyl-7-anilinofluoran, benzoyl leuco Methylene blue, 3-methyl-spirodinaphthofuran, etc. The acidic material may be a phenol derivative or an aromatic carboxylic acid derivative, for example, p-tert-butylphenol, 2,2-bis(p-hydroxyphenyl)propane, 1,1-bis(p-hydroxyphenyl) pentane, p-hydroxybenzoic acid, 3,5-di-tert-butylsalicylic acid, etc. Such thermal imaging materials and various combinations thereof are now well known, and various methods of preparing heat-sensitive recording elements employing these materials also are well known and have been described, for example, in U.S. Pat. Nos. 3,539,375, 4,401,717 and 4,415,633.

The reagent used to form a colored dye from a colorless precursor may also be an electrophile, as described, for example, in U.S. Pat. No. 4,745,046, a base, as described, for example, in U.S. Pat. No. 4,020,232, an oxidizing agent, as described, for example, in U.S. Pat. Nos. 3,390,994 and 3,647,467, a reducing agent, as described, for example, in U.S. Pat. No. 4,042,392, a chelatable agent, as described, for example, in U.S. Pat. No. 3,293,055 for spiropyran dyes, or a metal ion, as described, for example, in U.S. Pat. No. 5,196,297 in which thiolactone dyes form a complex with a silver salt to produce a colored species.

The reverse reaction, in which a colored material is rendered colorless by the action of a reagent, may also be used. Thus, for example, a protonated indicator dye may be rendered colorless by the action of a base, or a preformed dye may be irreversibly decolorized by the action of a base, as described, for example, in U.S. Pat. Nos. 4,290,951 and 4,290,955, or an electrophilic dye may be bleached by the action of a nucleophile, as described in U.S. Pat. No. 5,258,274.

Reactions such as those described above may also be used to convert a molecule from one colored form to another form having a different color.

The reagents used in schemes such as those described above may be sequestered from the dye precursor and brought into contact with the dye precursor by the action of heat, or alternatively a chemical precursor to the reagents themselves may be used. The precursor to the reagent may be in intimate contact with the dye precursor. The action of heat may be used to release the reagent from the reagent precursor. Thus, for example, U.S. Pat. No. 5,401,619 describes the thermal release of a Bronsted acid from a precursor molecule. Other examples of thermally-releasable reagents may be found in “Chemical Triggering”, G. J. Sabongi, Plenum Press, New York (1987).

Two materials that couple together to form a new colored molecule may be employed. Such materials include diazonium salts with appropriate couplers, as described, for example, in “Imaging Processes and Materials” pp. 268-270 and U.S. Pat. No. 6,197,725, or oxidized phenylenediamine compounds with appropriate couplers, as described, for example, in U.S. Pat. Nos. 2,967,784, 2,995,465, 2,995,466, 3,076,721, and 3,129,101.

Yet another chemical color change method involves a unimolecular reaction, which may form color from a colorless precursor, cause a change in the color of a colored material, or bleach a colored material. The rate of such a reaction may be accelerated by heat. For example, U.S. Pat. No. 3,488,705 discloses thermally unstable organic acid salts of triarylmethane dyes that are decomposed and bleached upon heating. U.S. Pat. No. 3,745,009 reissued as U.S. Pat. No. Re. 29,168 and U.S. Pat. No. 3,832,212 disclose heat-sensitive compounds for thermography containing a heterocyclic nitrogen atom substituted with an —OR group, for example, a carbonate group, that decolorizes by undergoing homolytic or heterolytic cleavage of the nitrogen-oxygen bond upon heating to produce an RO+ ion or RO′ radical and a dye base or dye radical which may in part fragment further. U.S. Pat. No. 4,380,629 discloses styryl-like compounds which undergo coloration or bleaching, reversibly or irreversibly via ring-opening and ring-closing in response to activating energies. U.S. Pat. No. 4,720,449 describes an intramolecular acylation reaction which converts a colorless molecule to a colored form. U.S. Pat. No. 4,243,052 describes a pyrolysis of a mixed carbonate of a quinophthalone precursor which may be used to form a dye. U.S. Pat. No. 4,602,263 describes a thermally-removable protecting group which may be used to reveal a dye or to change the color of a dye. U.S. Pat. No. 5,350,870 describes an intramolecular acylation reaction which may be used to induce a color change. A further example of a unimolecular color-forming reaction is described in “New Thermo-Response Dyes: Coloration by the Claisen Rearrangement and Intramolecular Acid-Base Reaction Masahiko Inouye, Kikuo Tsuchiya, and Teijiro Kitao, Angew. Chem. Int. Ed. Engl. 31, pp. 204-5 (1992).

It is not necessary that the colored material formed be a dye. The colored species may also be, for example, a species such as a metal or a polymer U.S. Pat. No. 3,107,174 describes the thermal formation of metallic silver (which appears black) through reduction of a colorless silver behenate salt by a suitable reducing agent. U.S. Pat. No. 4,242,440 describes a thermally-activated system in which a polyacetylene is used as the chromophore.

Physical mechanisms may also be used. Phase changes leading to changes in physical appearance are well known. The phase change may for example lead to a change in scattering of light. Thermally-activated diffusion of dye from a restricted area, thereby changing its covering power and apparent density, has also been described in “A New Thermographic Process”, by Shoichiro Hoshino, Akira Kato, and Yuzo Ando, Symposium on Unconventional Photographic System, Washington D.C. Oct. 29, 1964.

Image-forming layers 14 and 16 may comprise any of the image-forming materials described above, or any other thermally-activated colorants, and are typically from about 0.5 μm to about 4.0 μm in thickness, preferably about 2 μm. In the case where image-forming layers 14 and 16 comprise more than one layer, each of the constituent layers are typically from about 0.1 μm to about 3.0 μm in thickness. Image-forming layers 14 and 16 may comprise dispersions of solid materials, encapsulated liquid, amorphous or solid materials or solutions of active materials in polymeric binders, or any combinations of the above.

Interlayer 18 is typically from about 3 to about 30 μm in thickness, preferably about 6-10 μm. Interlayer 18 may comprise any suitable materials. A suitable interlayer composition includes 3 parts by weight of styrene butadiene latex, (DL277 NAB available from Dow chemical Co.), 1 part by weight of polyvinyl alcohol (Cevol205 available from Celanese Chemicals) with Glyoxal (available from Aldrich chemicals) and a surfactant (Zonyl FSN available from duPont). Interlayer 18 may be coated from a suitable solvent such as cyclohexane, methylcyclohexane and the like.

Although not shown in FIG. 1, the imaging member may have a protective overcoat layer deposited on image-forming layer 14 according to the method of the invention. The overcoat layer is typically from about. 1 μm to about 3 μm and is preferably coated from a solution having from about 15% to about 35% solids.

Generally, a formulation is prepared which includes at least one oligomer which includes an acrylate function. An oligomer is defined as a polymer which consists of only a few monomer units such as dimers, trimers, tetramers, etc. or mixtures thereof. See CRC Handbook, CRC Press LLC, © 1989. The upper limit of repeating units in an oligomer is about ten. The term telomer is sometimes used synonymously with oligomer. It is preferred that the oligomer have from about 2 to about 6 repeating acrylate units. Suitable oligomers for use according to the invention are: Ebercryl 8800 and Ebercryl 8807, both aliphatic urethane acrylates; Ebercryl 230 and Ebercryl 244, both aliphatic urethane diacrylates; Ebercryl 4866, an aliphatic urethane triacrylate; and Ebercryl 8301, an aliphatic urethane hexacrylate, commercially available from UCB Chemical Co. Epoxy acrylate oligomers can also be used.

The formulation may also include an optional monomer which has an acrylate function. Such monomers can be used to confer different properties to the layer being formed such as, for example, to affect the hardness and flexibility of the layer. Suitable monomers include: HDODA, a 1,6-hexanediol diacrylate and ODA-N an octyl/decyl acrylate, commercially available from UCB Chemical Co; isobornyl acrylate, Ebercryl 111, an aliphatic monoepoxide acrylate, tripropylene glycol diacrylate (TRPGDA), and trimethylolpropane ethoxy triacrylate (TMPEOTA)

The formulation also includes a photoinitiator which can initiate polymerization of the oligomer and the monomer, when present. Suitable photoinitiators include those which form a free radical which then initiates a free radical polymerization reaction or one which forms a Lewis Acid which then initiates a cationic polymerization reaction. A suitable photoinitiator is Irgcure 651, an alpha, alpha-dimethoxy-alpha-phenylacetophenone, commercially available from Ciba Specialty Chemicals. Optionally, the formulation may also include a photosensitizer. A suitable photosensitizer is Chivacure BMS, commercially available from Chitec Chemical Co. Ltd., Taiwan.

A preferred oligomer for use in the formation of the overcoat layer is Ebercryl 4842, an aliphatic urethane diacrylate with reacted silicone, commercially available from UCB Chemical Co.

The formulations from which the overcoat layer is formed according to the invention may also include other additives. For example, the overcoat layer may include friction reducing slip agents such as Ebercryl 350, a silicone diacrylate, commercially available from UCB Chemical Co. and Fave 4101, a fluorinated vinyl ether, commercially available from Honeywell Corp. The overcoat layer can also include light stabilizers and colloidal silica, for example, Nissan Colloidal silica (NCS) (available from Nissan Chemical America Corp., Houston, Tex.) which serves as an abrasive to maintain print head cleanliness. The overcoat layer and the interlayer can also include anti-oxidants and/or oxygen scavengers.

The formulation can be coated neat or preferably dissolved or dispersed in an organic solvent such as methyl ethyl ketone (MEK), toluene and the like or mixtures thereof.

The formulation can be coated on the preceding layer by any suitable coating apparatus such as a slot die coating apparatus and the member is then typically heated in an oven at a temperature of about 60° C., for example, to drive off solvent. The member then is subjected to ultraviolet or electron beam radiation, preferably in a heated chamber, for example at a temperature of from about 40° C. to about 65° C., which has been purged with nitrogen. The intensity and duration of the ultraviolet and electron beam radiation will vary with the type of layer being formed. Routine scoping experiments can be carried out to determine the optimum parameters for any particular application. Generally the coated layer is subjected to ultraviolet light of from about 200 to about 400 watts/in² for from 0.05 to about 0.5 second.

The ultraviolet radiation may be supplied by any suitable apparatus. A suitable apparatus is the EPIQ 6000, commercially available from Fusion UV Systems, Inc. In a preferred embodiment, two ultraviolet light providing units are mounted in line in the chamber.

The thermal imaging members of the invention may also include thermal backcoat layers. In a preferred embodiment of the imaging member shown in FIG. 1, there is included a barrier coating. The barrier layer may comprise water and gas inhibiting materials.

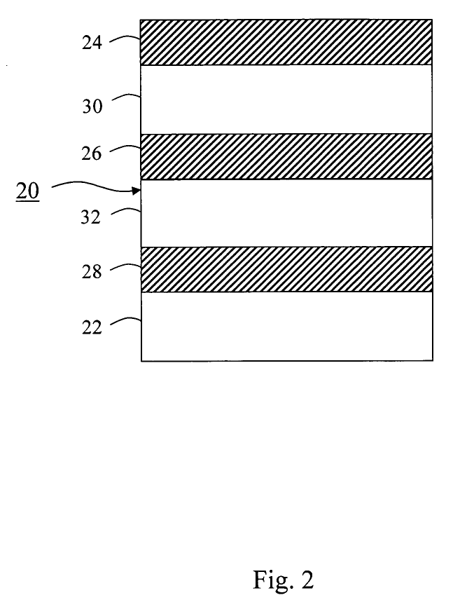

There will now be described with respect to FIGS. 2-6, other thermal imaging members upon which overcoat layers can be formed according to the invention. Referring now to FIG. 2 there is seen a three color thermal imaging member which can be manufactured according to the invention. The three color imaging member 20 includes substrate 22, cyan, magenta and yellow image-forming layers, 24, 26 and 28, respectively, and spacer interlayers 30 and 32. Preferably, interlayer 30 is thinner than interlayer 32 so long as the materials comprising both layers have the same heat capacity and thermal conductivity. The activation temperature of layer 24 is higher than that of layer 26 which in turn is higher than that of layer 28.

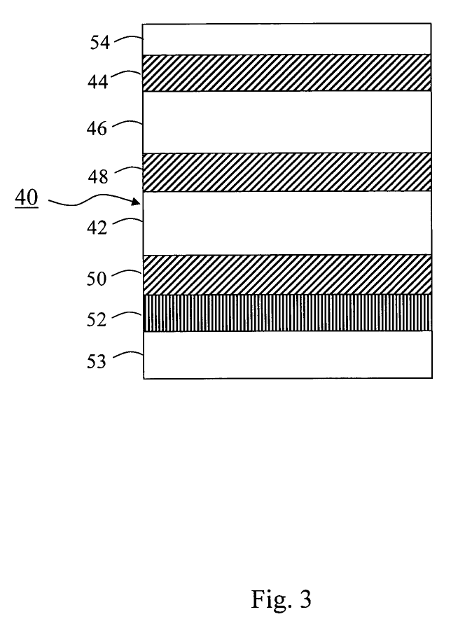

FIG. 3 illustrates a multicolor thermal imaging member which can be manufactured according to the invention wherein two image-forming layers are arranged on one side of a substrate and one image-forming layer is arranged on the other side of the substrate. Referring now to FIG. 3 there is seen imaging member 40 which includes a substrate 42, a first image-forming layer 44, interlayer 46, a second image-forming layer 48, a third image-forming layer 50, an optional white or reflective layer 52, a backcoat layer 53 and an overcoat layer 54. In this preferred embodiment substrate 42 is transparent. The image-forming layers and the interlayer may comprise any of the materials described above for such layers. Optional layer 52 may be any suitable reflective material or may comprise particles of a white pigment such as titanium dioxide. Protective backcoat and overcoat layers, 53 and 54 respectively, may comprise any suitable materials providing the functions of lubrication, heat resistance, UV, water and oxygen barrier properties, etc. Such materials may comprise polymeric binders in which appropriate small molecules are dissolved or dispersed, as will be familiar to those skilled in the art. The activation temperature of image-forming layer 48 is lower than that of image-forming layer 44 and the activation temperature of image-forming layer 50 can be the same as that of image-forming layer 48 or higher or lower and may be as low as possible consistent with the requirement of room temperature and shipping stability.

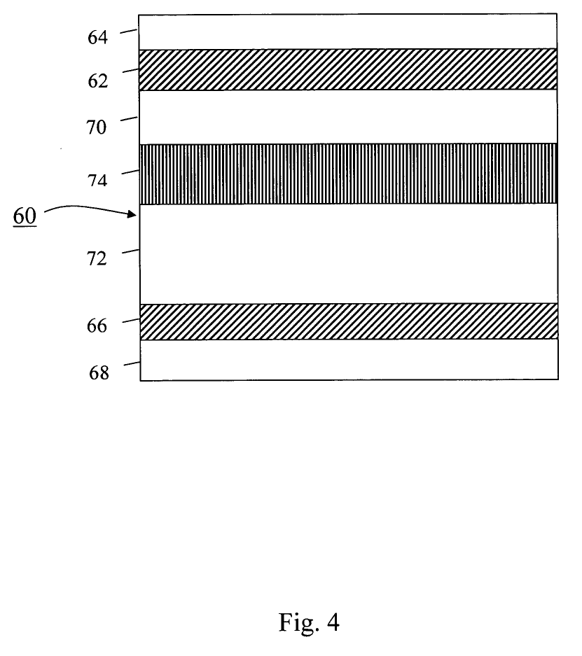

Another thermal imaging member is illustrated in FIG. 4. Referring to FIG. 4 there is seen a thermal imaging member 60 which includes a layer of a magenta image-forming material 62, in this illustrative instance a leuco dye, associated with a layer 64 of an acid developer material having a melting point, T₇ and a layer of a cyan image forming material 66 associated with a layer 68 of an acid developer material having a melting point, T₈. The imaging member 60 also includes first and second timing layers, 70 and 72, respectively, and a layer 74 of a fixing material having a melting point, T₉. Imaging member 60 may also include a substrate (not shown) which may be positioned adjacent layer 64 or layer 68.

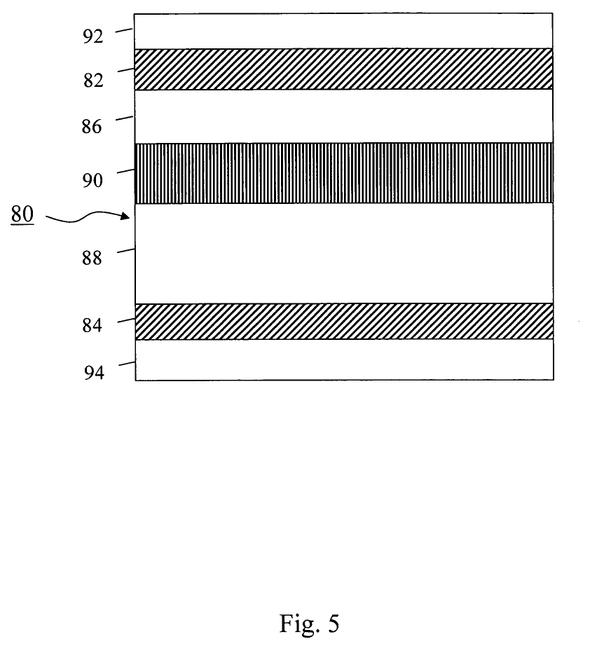

A negative working version of a two-color imaging member which can be manufactured according to the invention is illustrated in FIG. 5. In this implementation the dye layers are initially colored, and they remain so unless an adjacent layer of decolorizing reagent thermally activated before the arrival of the fixing reagent through a timing layer. Referring now to FIG. 5 there is seen a negative working thermal imaging member 80 according to the invention which includes a first image-forming layer 82, e.g., a magenta dye layer, a second image-forming layer 84, e.g., a cyan dye layer, first and second timing layers 86 and 88, respectively, a fixing layer 90 and first and second decolorizer layers 92 and 94, respectively. Imaging member 80 may also include a substrate (not shown) which may be positioned adjacent layer 92 or layer 94.

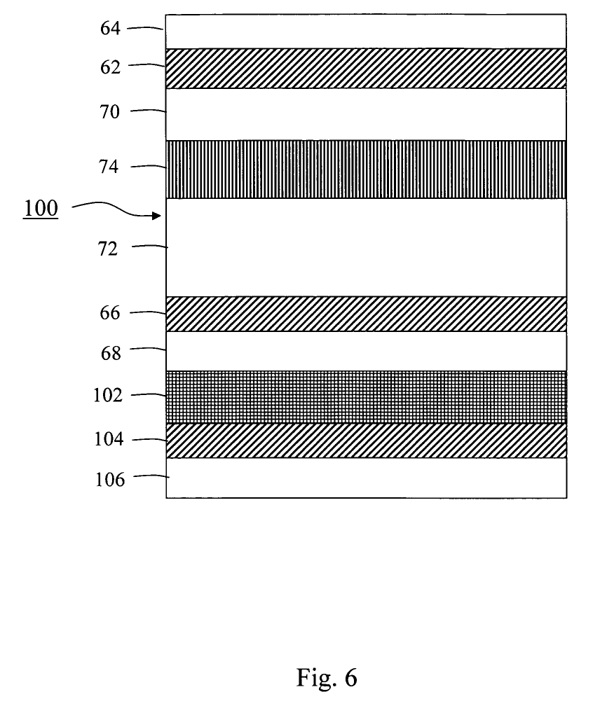

FIG. 6 illustrates a three-color thermal imaging member. Referring now to FIG. 6 there is seen imaging member 100 which includes the layers shown for the imaging member 60 which is illustrated in FIG. 16 and these layers are designated by the same reference numerals. Imaging member 100 also includes a buffer layer 102, yellow dye precursor layer 104 and a third acid developer layer 106 in which the developer material has a melting point T₁₀ which is higher than T₇ and T₈. After forming the desired color densities in cyan and magenta as described above in relation to FIG. 16, the temperature of the imaging member can be raised above T₁₀ to form a selectable density of yellow dye. It should be noted that where T₁₀ is a temperature higher than the imaging member 100 is likely to encounter during its useful life, it is not necessary to inactivate the yellow dye precursor subsequent to writing the yellow image. Imaging member 100 may also include a substrate (not shown) which may be positioned adjacent layer 64 or layer 106.

In choosing the layer dimensions for the imaging members illustrated in FIGS. 4 and 6 it is advantageous to have the timing layer 70 be as thin as possible but not substantially thinner than dye layer 62. Timing layer 72 typically will be about two to three times the thickness of timing layer 70.

### EXAMPLES

The method of the invention will now be described further with respect to specific preferred embodiments by way of examples, it being understood that these are intended to be illustrative only and the invention is not limited to the materials, amounts, procedures and process parameters, etc. recited therein. All parts and percentages are by weight unless otherwise specified.

### Example I

An overcoat layer (54) for a thermal imaging member such as that shown in FIG. 3 was formed from each of the following formulations:

| A | | B | | C | |
|---|---|---|---|---|---|
| Ebercryl 8301 | 75% | Ebercryl 4866 | 75% | Ebercryl 4842 | 75% |
| HDODA | 18% | HDODA | 18% | HDODA | 18% |
| BMS | 4% | BMS | 4% | BMS | 4% |
| Irgcure 651 | 2% | Irgcure 651 | 2% | Irgcure 651 | 2% |
| Fave 4101 | 1% | Fave 4101 | 1% | Fave 4101 | 1% |

Coating formulations were prepared which comprised 30% solids and 70% MEK. The overcoat layers were coated with a Meyer rod at a thickness of about 1.5 μm and were processed as described previously by being inserted in a heated oven to drive off the solvent and then inserted in a chamber which had been purged with nitrogen and subjected to ultraviolet energy in the range of from about 200 to about 400 watts/in² provided by two EPIQ 6000 units (having an H bulb) mounted in line for from 0.05 to about 0.5 second.

### Example II

An overcoat layer (54) for a thermal imaging member such as that shown in FIG. 3 was formed from each of the following formulations:

| D | | E | | F | | G | |
|---|---|---|---|---|---|---|---|
| Ebercryl 4866 | 54.7% | Ebercryl 230 | 74% | Ebercryl 230 | 74% | Ebereryl 244 | 74% |
| HDODA | 13.1% | HDODA | 18% | ODA-N | 18% | HDODA | 18% |
| BMS | 3.0% | BMS | 4% | BMS | 4% | BMS | 4% |
| Irgacure 651 | 1.5% | Irgacure 651 | 2% | Irgacure 651 | 2% | Irgacure 651 | 2% |
| Fave 4101 | 0.8% | Fave 4101 | 1% | Fave 4101 | 1% | Fave 4101 | 1% |
| NCS | 26.0% | | | | | | |
| Ebercryl 350 | 1.0% | Ebercryl 350 | 1% | Ebercryl 350 | 1% | Ebercryl 350 | 1% |

The overcoat layers were formed in accordance with the method described in Example I.

Although the invention has been described in detail with respect to various preferred embodiments, it is not intended to be limited thereto, but rather those skilled in the art will recognize that variations and modifications are possible which are within the spirit of the invention and the scope of the appended claims.

What is claimed is:

1. A method for forming an overcoat layer for a multilayer thermal imaging member comprising
(a) providing on the surface of a layer of the multilayer thermal imaging member a layer of a overcoat composition comprising an oligomer having an acrylate function and a photoinitiator; and
(b) subjecting said overcoat composition layer to a sufficient amount of ultraviolet or electron beam radiation to initiate a polymerization reaction whereby an overcoat layer is formed.

2. The method as defined in claim 1 wherein step (b) comprises subjecting said overcoat composition layer to ultraviolet radiation of from about 200 watts/in² to about 400 watts/in² for from about 0.5 to about 0.5 second.

3. The method as defined in claim 2 wherein step (b) is carried out in a chamber at a temperature of from about 40° C. to about 60° C., substantially in the absence of oxygen.

4. The method as defined in claim 3 wherein said overcoat layer is from about 1 μm to about 3 μm in thickness.

5. The method as defined in claim 1 wherein said overcoat composition further includes a monomer having an acrylate function.

6. The method as defined in claim 5 wherein said overcoat composition further includes a photosensitizer.

7. The method as defined in claim 6 wherein said overcoat composition further include colloidal silica.

8. The method as defined in claim 1 wherein said oligomer has from 2 to about 6 repeat acrylate units.

9. The method as defined in claim 1 wherein said oligomer is an aliphatic urethane acrylate.

10. A multilayer thermal imaging member comprising a substrate carrying at least one color-forming layer and an overcoat layer overlying said color-forming layer, said overcoat layer being formed by the method as defined in claim 1.

11. The multilayer thermal imaging member as defined in claim 10, wherein a first side of said substrate carries at least two color-forming layers and said overcoat layer overlies said at least two color-forming layers.

12. The multilayer thermal imaging member as defined in claim 11, and further including a color-forming layer carried by a second side of said substrate.
